(19) United States
(12) Patent Application Publication
(10) Pub. No.: US 2003/0051152 A1
(43) Pub. Date: Mar. 13, 2003

(54) Method and device for storing and reading digital data on/from a physical medium

(76) Inventors: Luc Wuidart, Pourrieres (FR); Pierre Balthazar, Aix En Provence (FR)

Correspondence Address: WOLF GREENFIELD & SACKS, PC, FEDERAL RESERVE PLAZA, 600 ATLANTIC AVENUE, BOSTON, MA, 02210-2211, US

(21) Appl. No.: 10/238,485

(22) Filed: Sep. 10, 2002

(30) Foreign Application Priority Data
Sep. 11, 2001 (FR) 01/11718

(51) Int. Cl. H04L 9/32

(52) U.S. Cl. 713/193

(57) ABSTRACT

A method and a device of secure storage, by a recorder, of digital data on a physical medium equipped with calculation circuitry, including, in a first use of the medium in write mode, the steps of: storing in the medium or its calculation circuitry, and in a non-volatile manner, at least one identifier of a reader of the medium; and storing the data in a coded manner by a coding key permanently contained in said medium or its calculation circuitry. A method and device for reading such coded data.

### BACKGROUND OF THE INVENTION

1. Field of the Invention

The present invention relates to the storing of digital data, more specifically, multimedia data, on a physical medium. The present invention more specifically relates to the protecting of the data contained on the medium against reproductions unauthorized by the creator of the concerned medium. “Medium creator” designates he who has, first, stored the data on the concerned physical medium. It is thus not necessarily the author of the content of the multimedia data, nor the medium manufacturer.

2. Discussion of the Related Art

An example of application of the present invention is multimedia media intended to receive music or image files in digital form.

It has already been provided to encode or encrypt the data stored on a multimedia medium (for example, a CD-ROM, a digital floppy disk, etc.) so that the data can only be read by a determined reader holding the encryption key. However, unless one individualizes the medium manufacturing and the data storage upon manufacturing to individualize the key according to the user, a same medium can be read by any reader holding the key. Now, the object precisely is to forbid the reading from the physical medium by an unauthorized reader.

An example of a system of protection against illicit copies of any digital medium is described in note “Content protection for recordable media specification”—“Introduction and common cryptographic elements”, published by 4C-entity, Rev 0.93, on Jun. 28, 2000 which is incorporated herein by reference.

Known systems have the additional disadvantage of not enabling a user of a recording device to protect his own data, for example, his digital photographs upon recording on a storage disk. Only the manufacturer can protect the data.

### SUMMARY OF THE INVENTION

The present invention aims at improving systems of protection of digital data, contained on physical media, against copies unauthorized by the author or the like.

The present invention also aims at enabling any creator of a recorded medium (the user of a reader-recorder or of the storage means), to protect the data upon recording on the medium.

The present invention also aims at keeping the possibility to protect the data upon manufacturing while enabling selection of authorized readers.

The present invention also aims at having the creator of the recorded medium himself select, upon recording, the reader(s) allowed to read the data contained in the storage means.

The present invention also aims at making it possible to modify the content of the storage medium as well as the readers allowed to read its data, after a first recording, provided that this is performed by the creator of the recorded medium.

To achieve these and other objects, the present invention provides a method of secure storage, by a recorder, of digital data on a physical medium equipped with a calculation means, including, in a first use of the medium in write mode, the steps of:

storing in the medium or its calculation means, and in a non-volatile manner, at least one identifier of a reader of the medium; and

storing the data in a coded manner by means of a coding key permanently contained in said medium or its calculation means.

According to an embodiment of the present invention, the coding key is transmitted to the recorder in an encrypted manner by means of a symmetrical algorithm with sharing of the encryption key with no transmission thereof.

According to an embodiment of the present invention, the algorithm takes into account an identifier of the recorder.

According to an embodiment of the present invention, the coding key is transmitted to the recorder in an encrypted manner by means of an asymmetrical encryption key transfer algorithm.

According to an embodiment of the present invention, upon first use of the medium in write mode, at least one authentication code of a user is stored on the medium or its calculation means in a non-volatile manner.

According to an embodiment of the present invention, said calculation means is an integrated circuit.

According to an embodiment of the present invention, the coding key is contained in the calculation means, preferably, at least partially in a physical parameter network of the integrated circuit.

According to an embodiment of the present invention, the medium is divided into sectors, an identification code and/or an authentication code being assigned to each sector or group of sectors.

According to an embodiment of the present invention, the storage method includes the steps of:

transmitting from the recorder to the physical medium a list of identifiers of authorized readers;

storing this list in the physical medium;

transmitting from the physical medium to the recorder a coding key encrypted by an encryption key sharing or transfer algorithm;

decrypting said coding key on the recorder side;

coding, on the recorder side, the data to be stored; and

transmitting the coded data to the physical medium.

The present invention also provides a method of reading, by a reader, of coded digital data on a physical medium equipped with a calculation means, including the steps of:

communicating an identifier of the reader to the medium;

checking, on the physical medium side, whether the reader belongs to a list of authorized readers, pre-recorded in the medium or its calculation means; and

if it is, transmitting to the reader the coded data and an encrypted coding key, to enable said reader to decode the data.

According to an embodiment of the present invention, the encryption of the coding key is performed by said calculation means of the physical medium by means of a symmetrical algorithm sharing an encryption key with no transmission thereof.

According to an embodiment of the present invention, the algorithm takes the reader identifier into account.

According to an embodiment of the present invention, the encryption of the coding key is performed by said calculation means of the physical medium by means of an asymmetrical encryption key transfer algorithm.

According to an embodiment of the present invention, in case of a negative checking of the existence of the reader in the authorized reader list, the following steps are carried out:

requiring an authentication code;

comparing this code with a code pre-recorded in the physical medium or its calculation means; and

in case the codes are identical: allowing for a modification of the authorized reader list on the physical medium or its calculation means.

The present invention also provides a digital data physical medium, including an integrated circuit.

The present invention also provides a recorder of digital data on a physical medium.

The present invention further provides a reader of digital data from a physical medium.

The foregoing objects, features and advantages of the present invention, will be discussed in detail in the following non-limiting description of specific embodiments in connection with the accompanying drawings.

### BRIEF DESCRIPTION OF THE DRAWINGS

FIG. 1 very schematically shows an embodiment of a secure storage system according to the present invention;

FIG. 2 illustrates, in a simplified flowchart, a preferred embodiment of the storage method according to the present invention;

FIG. 3 illustrates in a simplified flowchart a preferred embodiment of a data reading method according to the present invention; and

FIG. 4 illustrates in a simplified flowchart a preferred embodiment of a method for updating a list of authorized readers and/or the content of a physical medium according to the present invention.

### DETAILED DESCRIPTION

Same elements and method steps have been designated with same references in the different drawings. For clarity, only those elements of the system and those method steps that are necessary to the understanding of the present invention have been shown in the drawings and will be described hereafter. In particular, the calculations implemented by the actual encryption and coding algorithms have not been described in detail and only use current operations. Further, the means of data exchange between the readers-recorders and the data media have not been described in detail.

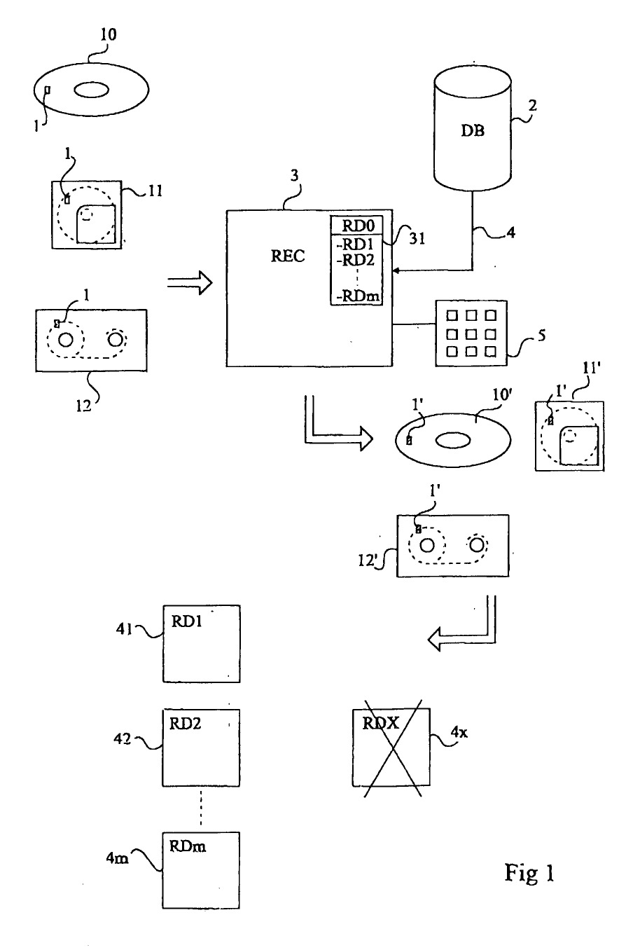

FIG. 1 is a very simplified representation of a system of secure storage and exploitation of data stored on physical media according to the present invention.

A physical medium usable in the context of the present invention is formed by any digital data storage physical medium, provided that it can include or be equipped with a calculation means. For example, and as illustrated in FIG. 1, it may be a CD-ROM 10, a disk 11, a digital tape 12. According to the present invention, these media are provided with a calculation means, for example, an integrated circuit chip 1. This chip is physically placed on the actual medium. Chip 1 is intended to contain an authentication and/or coding key and to execute certain authentication and encryption calculations, as will be seen hereafter. As an alternative, the key(s) are stored in an area of the physical medium. Different means may be used to associate an integrated circuit chip or the like with a digital data storage physical medium. An example of a physical data medium equipped with a chip is described in document FR-A-2,751,767 which is incorporated herein by reference. The physical medium and the chip may even be confounded, for example, in the case of a smart card provided with high-capacity digital memories (of several megabytes), for example, a flash memory.

Digital data to be stored (for example, audio or video files) are initially contained in a source element, for example, a data base 2 (DB). It may also be a distant data source coming from a private digital network (Intranet) or a public digital network (Internet), or any other element containing multimedia digital data. It may even be a physical storage medium 10, 11, or 12 of the type of those provided by the present invention.

To store digital data contained in the source element on a physical medium of the present invention, a recorder 3 (REC) or reader-recorder able to receive, over a link 4, the data contained in database 2, and including means for reading/writing (not detailed) from/on at least one of physical media 10, 11, or 12 is used.

Recorder 3 of the present invention reproduces, after having coded them as will be described hereafter, the multimedia digital data on the adapted medium. According to the present invention, recorder 3 also triggers the storage, in chip 1 or the like of physical medium 10, 11, or 12, of a list of identification codes of readers RDi allowed to read the data. Thus, recorder 3 of the present invention contains a list 31 (RD1, RD2, . . . , RDi, . . . RDm) of digital identifiers of readers for which the creator of the medium allows, in the future, the reading of the data stored in the physical medium that it provides. This list is, for example, typed by the creator by means of a keyboard 5 associated with the recorder or downloaded from the source element, etc. The recorded media, provided by recorder 3, have been illustrated in FIG. 1 under references 10′, 11′, and 12′. The corresponding chips have been hatched and designated with reference 1′ to indicate their modified state.

In the example of FIG. 1, recorder 3 also is a reader having RD0 as an identifier. This identifier is also contained in list 31 recorded on chip 1′.

Subsequently, the recorded media may be read by any authorized reader 41, 42, . . . 4m. These readers are, according to the present invention, able to decode the data from the moment when the chip of the physical medium contains their identifier (RD1, RD2, . . . RDm). This identifier enables, as will be seen hereafter, the medium to transmit the coding key otherwise unknown by the reader. However, if the physical medium is introduced into an unauthorized reader 4x (of identifier RDx), said reader will be unable to restore the multimedia data since the coding key will not be communicated to it.

According to a preferred embodiment of the present invention, more specifically intended to enable updating data stored on the physical medium and/or updating the list of authorized readers, it is provided to store, during the first recording of the medium, an authentication code of the user in integrated circuit chip 1′. For example, the creator of the recorded medium uses keyboard 5 or any other functionally equivalent means to provide an authentication code and record it on the physical data medium (preferably, in the chip thereof) during the first use in storage or recording. Subsequently, a modification of the list of authorized readers and/or of the memorized data will be allowed if the medium user can provide this authentication code. If not, the list of authorized readers and the data contained in the physical medium will no longer be able to be modified.

A feature of the present invention is that the data coding key is specific to the chip located on or in the storage means, and is not linked to the readers. The same occurs for the optional user authentication key. Thus, the personalization (list of authorized readers) may be performed upon first recording of a virgin medium, which makes the system particularly versatile. It is however not excluded for the list of authorized readers to be fixed upon series manufacturing of the multimedia data medium. In this case, it is enough not to provide a possible update by typing of an authentication code and a protected multimedia data medium will be available, the reading of which will only be possible for readers having authorized identifiers, the other readers being unable to decrypt the data.

An advantage of the present invention is that the coding key needs not be recorded in the authorized readers, nor be communicated thereto by a third party. Only the physical medium contains this key, which enables its individualizing for each medium upon manufacturing. This individualization may even be different within a same medium. For example, an encryption key may be assigned to each side of a tape, or to each physical sector of the medium, possibly by groups of sectors.

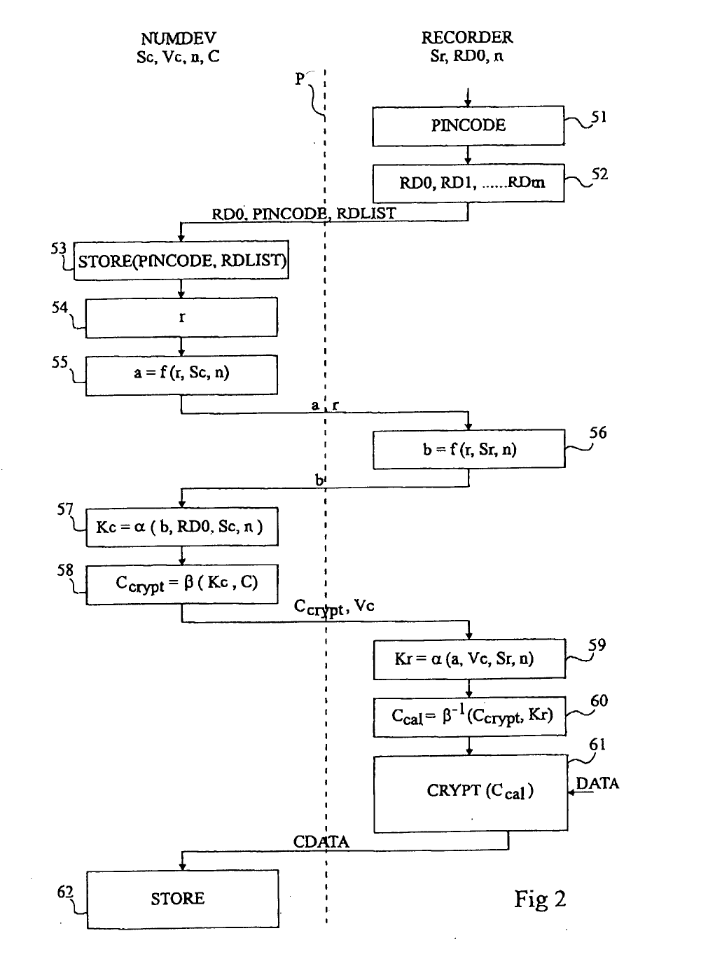

FIG. 2 illustrates, in a simplified flowchart, an embodiment of the secure data storage method according to the present invention. In FIG. 2, the steps executed in the recorder have been shown to the right of dotted lines P, and the steps performed on the physical medium side (NUMDEV), more specifically in its integrated circuit chip, have been shown to the left of dotted lines P.

According to the preferred embodiment of the present invention, the storage includes an authentication phase enabling calculation of an encryption key, a phase of encryption of the coding key, and a data coding phase. The authentication algorithm used is a symmetrical algorithm sharing a key with no transmission thereof. An example of such an algorithm is described, for example, in French patent application n°2,716,058. An algorithm known as the Diffie-Heliman algorithm and described, for example, in work “Applied cryptography” by B. Schneier, published by Wiley in 1996, pages 513 to 516, or in document U.S. Pat. No. 4,200,770, may also be used. The encryption of the coding key is, for example, performed by an algorithm known as the DES algorithm (Data Encryption Standard) and described, for example, in above-mentioned work “Applied cryptography”, pages 265 to 301. All of the references referred to in this paragraph are hereby incorporated by reference.

To implement the embodiment of FIG. 2, the integrated circuit chip, on the physical medium side, must contain four digital quantities or data, that is:

an authentication key Sc specific to the integrated circuit chip. It may be, for example, a binary word recorded in a non-volatile memory of the integrated circuit chip and/or a binary code coming from a physical parameter network. It thus is a secret quantity for implementing the authentication algorithm.

a so-called public quantity Vc for implementing the symmetrical authentication algorithm. This public key is a function of key Sc. It may be permanently contained in the integrated circuit chip (for example, recorded upon manufacturing of the physical medium), recorded in the chip at the time of the first data storage, or provided in the transition through the recorder or the reader upon execution of the algorithm.

coding key C of the data to be stored on the physical medium. Key C is not used to authenticate a reader, but to code the data. Key C is, here again as a feature of the present invention, stored in the integrated circuit chip, or even at least partially in a physical parameter network (PPN) directly on the silicon.

an integer n, specific to the authentication and encryption methods. More specifically, it is the modulo on which the different calculations are made.

On the recorder side, the necessary data are:

a secret authentication key Sr of the recorder (similar to key Sc, on the data medium side) and which thus is a secret quantity for the execution of the authentication algorithm.

identification code RDi (here, RD0) of the recorder. In the example of a Diffie-Hellman algorithm, code RDi is linked to key Sr and corresponds to the public key. As an alternative, and if this is compatible with the used algorithm, this identification code corresponds, for example, to the serial number or to the type number of the recording device.

the modulo n of the operations.

Quantities Sc and Vc are linked by relation Vc=gSc mod n, where g represents a cyclic group generator. Quantities Sr and RDi are linked by relation RDi=gSr mod n.

In the preferred embodiment of FIG. 2, the user first types (block 51) an authentication code which is specific to him (PINCODE). This authentication code is intended to be stored on the integrated circuit chip in a first recording to enable the user to subsequently identify himself to update the data. The algorithm described in FIG. 2 thus corresponds to the algorithm of a first data storage on a virgin physical medium.

The user then records (block 52) a list RDLIST of identifiers of authorized readers (RD0, RD1, . . . , RDi, . . . RDm). This is list 31 of FIG. 1 intended to also be stored in the integrated circuit chip. This list may be predetermined or not according to applications.

Data PINCODE, RDLIST, and RD0 are transmitted by the recorder to the physical medium, more specifically to its chip. Data PINCODE and RDLIST are stored (block 53) in a non-volatile list (STORE(PINCODE, RDLIST)) associated with the chip of the physical medium. As an alternative, if the list is recorded upon manufacturing of the physical medium, a non-rewritable and non-volatile memory will be used.

The next step includes, on the medium chip side, of drawing (block 54) a random quantity r.

Then, a quantity a is calculated (block 55), based on a function f taking amounts r, Sc, and n into account. For example, the function calculated at step 55 is:

a=rSc mod n.

Amounts a and r are then transmitted to the recorder, which, as for itself, calculates (block 56) a quantity b, based on function f identical to that implemented on the integrated circuit side and on amounts r, Sr, and n. Thus, referring to the above example, block 56 performs the following operation:

b=rSr mod n.

Amount b calculated by the recorder is retransmitted to the integrated circuit chip. Said chip then calculates (block 57) the shared key of the data coding algorithm, which key is designated as Kc, based on a function α using amounts b, RD0, Sc and n. In the example of a Diffie-Hellman algorithm, this amounts to performing the following operation:

Kc=(b*RD0)Sc mod n.

The integrated circuit chip on the physical medium side then encrypts (block 58) its secret data coding key C based on the symmetrical algorithm β (for example, of DES type) which uses as an argument encryption key Kc calculated at step 57. Function β provides an encrypted coding key Ccrypt.

Amounts Ccrypt and Vc are then transmitted to the recorder, which, as for itself, recalculates (block 59) an encryption key Kr implementing the same algorithm α, but applied to amounts a, Vc, Sr, and n. In the example of the Diffie-Hellman algorithm, this amounts to performing the following operation:

Kr=(a*Vc)Sr mod n.

Knowing encryption key Kr, the recorder reconstitutes the coding key to be applied to the data by applying the inverse algorithm of the symmetrical algorithm of step 58 on the integrated circuit side. This amounts to calculating (block 60) a coding key Ccal by implementing a function β-1 with arguments Ccrypt and Kr. With a symmetrical encryption algorithm, amount Ccal is equal to amount C corresponding to the secret quantity of the integrated circuit chip.

Other methods of encrypted transfer of secret key C of the chip may be implemented while taking account of the adapted security level. In addition to symmetrical algorithms such as that described in document FR-A-2,716,058, asymmetrical algorithms may also be used. For example, the algorithm known as the RSA algorithm may be used while ascertaining that the constraints of the protocol in the value definition are respected. Algorithm RSA will be used as an algorithm of encrypted transfer of the data coding key. An example of an RSA algorithm is described in above-mentioned work “Applied cryptography”, pages 466 to 474 and in document U.S. Pat. No. 4,405,829 which is incorporated herein by reference.

There then remains for the recorder to code (block 61) the data by using key Ccal. Any single-key data coding or encryption method may be used. For example, the algorithm described in article “MPEG Video Encryption in real time using secret key cryptography” by C. Shi, S-Y Wang, and B. Bhargave, published by the “Department of computer science of Purdue University” in 1999 may be applied which is incorporated herein by reference.

Coded data CDATA are then stored (block 62, STORE) by the recorder on the physical medium (here, not the integrated circuit chip but the actual physical data medium). This is the last step of the storage or recording method according to the present invention.

Once stored, data CDATA may only be decoded by a reader which is not only able to implement symmetrical authentication and encryption algorithms to recover coding key C, but which, moreover, is present in the list of authorized readers stored on the integrated circuit chip.

The fact for key Ccal, being a secret datum of the physical medium, to be known by the recorder, is not disturbing. Indeed, this secret datum which is specific to the physical medium could at most be reused to decode its own data. However, since the initial recorder corresponds to the user who has the most extended rights to set the conditions of use of the physical medium, for him to know this key is not disturbing.

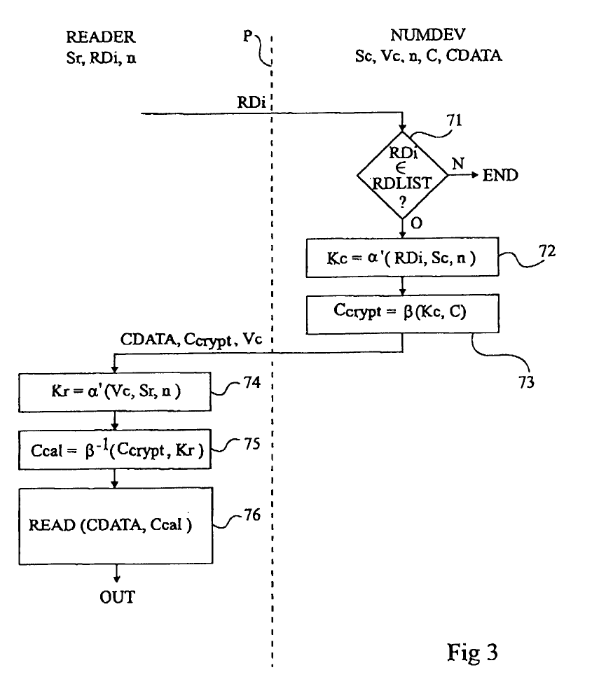

FIG. 3 illustrates, in a simplified flowchart, to be compared with that in FIG. 2, an embodiment of a method for reading (extracting) coded data from a physical medium according to the present invention. In FIG. 3, the steps performed on the reader side have been shown to the left of dotted lines P and the steps implemented on the physical medium side (NUMDEV) have been shown to the right of the dotted lines.

The known quantities or keys of the reader are Sr, n, and RDi, which form the reader identifier (in the example, its public key).

On the physical medium side, the used quantities or keys are Sc, Vc, n , and C, as in the storage. However, coded data CDATA are now also present.

The first step of the read process consists, for the reader (after introduction into the reader and execution of the usual starting procedures), of sending to the physical medium (more specifically, the integrated circuit) its identification code RDi.

On the physical medium side, it is checked (block 71) whether the reader belongs to the list (RDLIST) of authorized readers.

If not, the process stops (END) and the data reading that may be performed by the reader will not enable said reader to decode the data since it does not know the key.

If yes, the integrated circuit chip calculates (block 72) shared encryption key Kc. This amounts to executing a function α′ based on amounts RDi, Sc, and n. Function α′ is, preferably, the same as function α of the recording (the size of the shared key calculation program is thus reduced), the only difference being in the arguments used. In read mode, the authentication phase of steps 54 to 56 may be avoided. In the example of the Diffie-Hellman algorithm, this amounts to calculating at step 72:

Kc=RDiSc mod n.

The integrated circuit chip then encrypts (block 73) its secret coding key based on key Kc by implementing function β. Once key Ccrypt has been obtained, amount Vc and coded data CDATA are then transmitted to the reader.

On the reader side, shared encryption key Kr is calculated (block 74) by implementing a function α′ with data Vc, Sr, and n. In the example of the Diffie-Hellman algorithm, this amounts to executing the following operation:

Kr=VcSr mod n.

Then, the reader recalculates (block 75) a coding key by implementing the inverse function of function β on key Ccrypt and by using shared encryption key Kr.

The authorized reader then holds in its possession coding key Ccal of the data which corresponds to secret key C of the physical medium. It is then able to read (block 76) coded data CDATA by decoding them (READ(CDATA, Ccal)). The decoded data are then restored (OUT) by any conventional means according to the application of the reader.

The fact for the reader to know secret key C=Ccal of the physical medium is not disturbing. Indeed, this key is specific to the physical medium and the reader is authorized. Accordingly, the knowing of this key by an unauthorized third party would be of no use, be it to exploit another physical medium which would then have another coding key, or to use this physical medium in another reader since this other reader would not pass test 71 previous to the transmission of encrypted data CDATA by the integrated circuit chip.

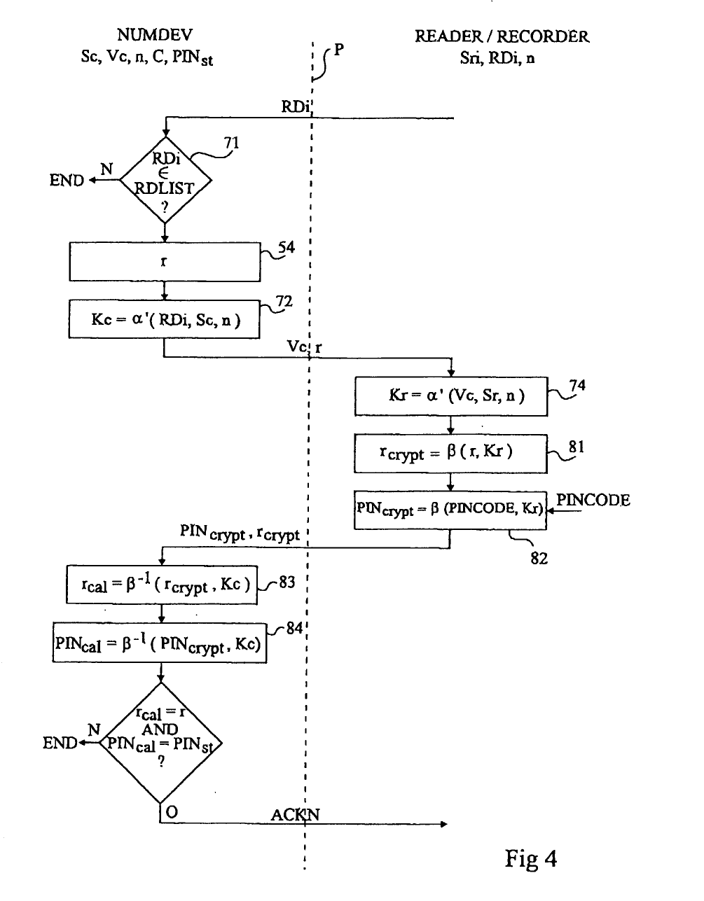

FIG. 4 illustrates an embodiment of a method for modifying the data stored in the physical medium of the present invention and/or in its chip. The steps executed on the reader/recorder side have been illustrated to the right of dotted lines P in FIG. 4. Those executed on the physical medium side (more specifically, by its integrated circuit chip) have been illustrated to the left of dotted lines P.

The data contained in the integrated circuit chip of the physical medium are Sc, Vc, n, C, and PINst, where PINst represents the authentication key of the user that he has memorized in the medium upon first recording (FIG. 2). This key was of course present during the read process, without however being used.

On the reader/recorder side, the used data are Sr, RDi, and n.

As for a reading, the reader/recorder starts identifying by transmitting its identifier RDi to the integrated circuit chip. Said circuit then tests (block 71) whether the reader is or not authorized. If not, the process stops (END).

If yes, the integrated circuit chip draws (block 54) random number r.

Then, it calculates (block 72) shared encryption key Kr based on data RDi, Sc, and n (function α′).

Quantities Vc and r are then transmitted by the integrated circuit chip to the reader/recorder, which then calculates (block 74) encryption key Kr on its side.

The next calculation (block 81) includes, on the reader/recorder side, of encrypting number r by implementing the symmetrical key encryption algorithm (function β) with key Kr. A number rcrypt is obtained.

The user then types his identification code (PINCODE) on the keyboard. The reader/recorder calculates (block 82) an encrypted code PiNcrypt based on encryption function β, on code PINCODE, and on key Kr.

Quantities PINcrypt and rcrypt are transmitted to the integrated circuit chip. Said chip calculates (block 83) a number real implementing inverse function β-1 applied to number rcrypt with key Kc as a decryption key.

Then, it recalculates (block 84) an authentication code PiNcal based on inverse function β-1 applied to encrypted code PINcrypt with key Kc as a decryption key.

It is then checked (block 85), on the integrated circuit chip side, whether number real does correspond to random number r of block 54 and whether identification code PINcal does correspond to identification code PINst, stored in the first recording. If not, the process stops (END). If yes, the integrated circuit chip transmits an acknowledgement signal (ACKN) to the reader/recorder which is then authorized to carry on the storage process. The checking of step 85 may be performed successively after the determination of numbers real and PiNcal, the order of which is not important.

The steps of FIG. 4 actually correspond to a checking of the reader authorization, then to an authentication of the reader and of the user. This enables making sure that only the authorized user can modify the stored data, or grant the right to read to a given device.

Afterwards, the communication protocol between the medium and the reader/recorder is performed in the same way as in the storage phase (FIG. 2).

An advantage of the present invention is that the coding and the decoding of the data are performed outside of the chip. Said chip thus requires no significant calculation capacity. It must only be sized to be able to recalculate the different encryption and coding keys as well as to contain the authentication code and the authorized reader list.

Another advantage of the present invention is that only the initial user (or a user authorized by him by being given code PINCODE) can modify or erase the stored data or modify the rights of access to the data.

Another advantage is that the used key sharing system enables providing one key per couple (physical medium, reader) without for all this having to store these keys in the readers.

It should be noted that, if an unauthorized reader sends a public identifier (RDi) representing the identifier of an authorized reader contained on list RDLIST, it must also have secret key Sr of the authorized reader to have access to coding key C, which is itself encrypted on the physical medium integrated circuit side by key Kc.

According to an alternative embodiment, the list of authorized readers is automatically updated upon insertion of the physical medium in an unknown reader. In this case, the updating process illustrated in FIG. 4 is automatically executed when an unknown reader of the chip transmits its identifier. The authentication code required from the user enables him to add this reader to the list. Such an alternative enables the authorized user to use the physical medium in any reader (for example, in a car radio, or at any other user's).

Of course, the present invention is likely to have various alterations, modifications, and improvement which will readily occur to those skilled in the art. In particular, any other symmetrical encryption algorithm than algorithm DES may be chosen. Said algorithm however has the advantage of being implementable by hardware means (in wired logic), of being fast and perfectly tried and tested.

Further, the key exchange Diffie-Hellman algorithm may also be replaced with any algorithm with a key sharing or transfer functionality.

Moreover, public keys Vc and RDi used by the encryption phase may be contained, respectively, somewhere else than in the medium and in the reader. They may be transmitted thereto by any system. For example, a system of transmission by means of a telecommunication network of the public keys to the readers and/or a system for reading bar codes representing the public keys, on the physical medium side, may be envisaged.

Such alterations, modifications, and improvements are intended to be part of this disclosure, and are intended to be within the spirit and the scope of the present invention. Accordingly, the foregoing description is by way of example only and is not intended to be limiting. The present invention is limited only as defined in the following claims and the equivalents thereto.

What is claimed is:

1. A method of secure storage, by a recorder, of digital data on a physical medium equipped with a calculation means, including, upon first use of the medium in write mode, the steps of:
storing in the medium or its calculation means, and in a non-volatile manner, at least one identifier of a reader of the medium; and
storing the data in a coded manner by means of a coding key independent from a reader and permanently contained in said medium or its calculation means.

2. The storage method of claim 1, wherein the coding key is transmitted to the recorder in an encrypted manner by means of a symmetrical algorithm with sharing of the encryption key with no transmission thereof.

3. The storage method of claim 2, wherein the algorithm takes into account an identifier of the recorder.

4. The storage method of claim 3, wherein the coding key is transmitted to the recorder in an encrypted manner by means of an asymmetrical encryption key transfer algorithm.

5. The storage method of claim 1, further including, upon first use of the medium in write mode, the step of storing at least one authentication code of a user on the medium or its calculation means in a non-volatile manner.

6. The storage method of claim 1, wherein said calculation means is an integrated circuit.

7. The storage method of claim 6, wherein the coding key is contained in the calculation means, preferably, at least partially in a physical parameter network of the integrated circuit.

8. The storage method of claim 1, wherein the medium is divided into sectors, an identification code and/or an authentication code being assigned to each sector or group of sectors.

9. The storage method of claim 1, including the steps of:
transmitting from the recorder to the physical medium a list of identifiers of authorized readers;
storing this list in the physical medium;
transmitting from the physical medium to the recorder a coding key encrypted by an encryption key sharing or transfer algorithm;
decrypting said coding key on the recorder side;
coding, on the recorder side, the data to be stored; and
transmitting the coded data to the physical medium.

10. A method for reading, by means of a reader, coded digital data on a physical medium equipped with a calculation means, including the steps of:
communicating an identifier of the reader to the medium;
checking, on the physical medium side, whether the reader belongs to a list of authorized readers, pre-recorded in the medium or its calculation means; and
if yes, transmitting to the reader the coded data and an encrypted coding key, to enable said reader to decode the data.

11. The reading method of claim 10, wherein the encryption of the coding key is performed by said calculation means of the physical medium by means of a symmetrical algorithm sharing an encryption key with no transmission thereof.

12. The reading method of claim 11, wherein the algorithm takes the reader identifier into account.

13. The reading method of claim 10, wherein the encryption of the coding key is performed by said calculation means of the physical medium by means of an asymmetrical encryption key transfer algorithm.

14. The reading method of claim 10, including, in case of a negative checking of the existence of the reader in the authorized reader list, the steps of:
requiring an authentication code;
comparing this code with a code pre-recorded in the physical medium or its calculation means; and
in case the codes are identical, allowing for a modification of the authorized reader list on the physical medium or its calculation means.

15. The reading method of claim 10, wherein the coded data have been stored by the storage method of claim 1.

16. A digital data physical medium, including an integrated circuit to implement the storage method of claim 1.

17. A digital physical medium, including an integrated circuit to implement the read method of claim 1.

18. A recorder of digital data on a physical medium, including means for implementing the storage method of claim 1.

19. A reader of digital data from a physical medium, including means for implementing the read method of claim 10.
